(19) United States
(12) Patent Application Publication
(10) Pub. No.: US 2026/0119061 A1
(43) Pub. Date: Apr. 30, 2026

(54) MEMORY-MAPPED I/O (MMIO) ADDRESS ALLOCATION

(71) Applicant: Intel Corporation, Santa Clara, CA (US)

(72) Inventors: Duane E. GALBI, Wayland, MA (US); Jeffrey HAGAN, Hopedale, MA (US); Robert FABER, Hopkinton, MA (US); George Leonard TKACHUK, Phoenix, AZ (US); Susanne M. BALLE, Hudson, NH (US); Hugh WILKINSON, Newton, MA (US)

(21) Appl. No.: 19/432,716

(22) Filed: Dec. 24, 2025

(51) Int. Cl. G06F 3/06

(52) U.S. Cl. CPC G06F 3/0631; G06F 3/0604; G06F 3/0679

(57) ABSTRACT

Examples described herein relate to allocate a first of multiple memory-mapped input/output regions to a first sub-non-uniform memory access cluster and allocate a second of the memory-mapped input/output regions to a second sub-non-uniform memory access cluster. In some examples, the second of the memory-mapped input/output regions can be allocated to a third sub-non-uniform memory access cluster. In some examples, a sub-non-uniform memory access cluster includes a core and a caching agent.

### BACKGROUND

Memory-Mapped I/O (MMIO) is a technology in which a processor communicates with peripheral devices (e.g., graphics processors, network interface devices, or storage) by accessing control registers and data buffers by accessing memory addresses, using memory access instructions. MMIO processing latency increases when the memory address space is split across multiple silicon dies (e.g., sockets) due to the delay in traversing a die where a core and the caching agent are on different dies.

### BRIEF DESCRIPTION OF THE DRAWINGS

FIG. 1 shows an example system.

FIG. 2 depicts an example of MMIO and DRAM memory address allocations.

FIG. 3A depicts an example of allocations of multiple MMIO regions in a processor socket.

FIG. 3B depicts an allocation of a MMIO region.

FIG. 4A depicts allocation of multiple MMIO regions to a sub-socket memory caching domain.

FIG. 4B shows an example of allocations of MMIO regions to cores.

FIG. 5A shows an example of allocations of MMIO regions to cores of sub sockets.

FIG. 5B shows an example allocation of caching agent to core.

FIG. 6A depicts an example of allocation of an MMIO region to an SNC.

FIG. 6B depicts an allocation of an MMIO region to a subsocket.

FIG. 7 depicts an example process.

FIG. 8 depicts an example system.

### DETAILED DESCRIPTION

Various examples can reduce latency by configuration of sub-non-uniform memory access (NUMA) clustering (SNC) so that MMIO requests stay within an allocated MMIO SNC cluster. Such a mode can split MMIO address space into multiple domains based on MMIO access latency. General memory SNC domains can be associated with a distinct set of core(s), caching agent(s), last-level cache(s), and memory controller(s). MMIO SNC regions be distinct from or coincident with the general memory SNC regions. A MMIO SNC region can correspond to a system socket, a general memory SNC domain, or less than a general memory SNC domains. By utilizing multiple MMIO SNC regions, a core and caching agent associated with a MMIO SNC region of the multiple MMIO regions can be in relative physical proximity and MMIO latency can be reduced. MMIO SNC regions allow for lower latency from MMIO accesses to devices through an input output (I/O) circuitry (e.g., read or write) and hence lower power usage.

A caching region can include a set of caching agents that can cache the full memory space of the processor. For example, in a two socket system, each socket is associated with a different caching region. Some processors have multiple full memory space caching regions (e.g., sub socket regions) within the same socket. A single or multiple general memory SNC regions can exist within a caching domain. Various examples provide multiple MMIO SNC regions within a caching domain, having MMIO using only a subset of the available caching agents within a caching domain, and having multiple MMIO specific caching regions within the processor's full memory caching region. An MMIO region allocated to a strict subject of caching agents in an SNC.

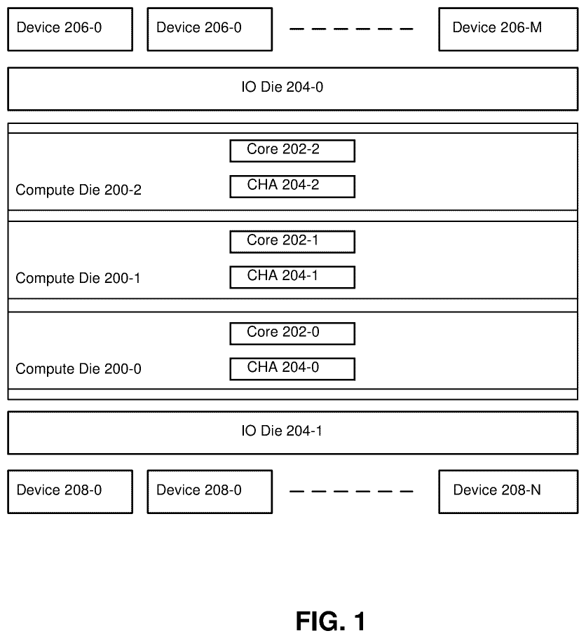

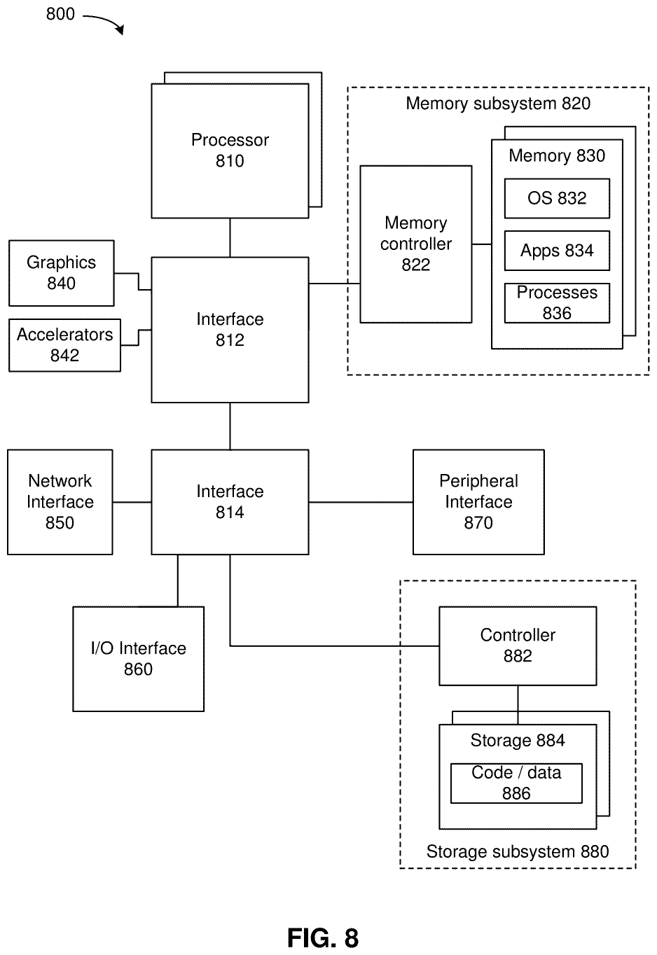

FIG. 1 shows an example system. Compute dies 200-0 to 200-2 can include respective processor core 202-0 to 202-2 and caching and home agent (CHA) 204-0 to 204-2 as well as other circuitry and software described at least with respect to FIG. 8. In some examples, a CHA can be part of an uncore (e.g., system agent) and the uncore can include or more of: a memory controller, a shared cache (e.g., last level cache (LLC)), a cache coherency manager, arithmetic logic units, floating point units, core or processor interconnects, or bus or link controllers. While examples depict CHA, instead a CHA can include both caching agent and home agent, a caching agent, or a home agent.

A processor core of processor cores 202-0 to 202-2 can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor cores 202-0 to 202-2 can be heterogeneous or homogeneous processor types where processors in different sockets are a same type (e.g., central processing unit (CPU), graphics processing unit (GPU), network processing unit (NPU), etc.) or different type (e.g., a first socket includes a CPU and a GPU and a second socket includes a GPU and an NPU).

Circuitry on compute dies 200-0 to 200-2 can access devices 206-0 to 206-M, where M is an integer, and devices 208-0 to 208-N, where N, is an integer via respective input output (IO) dies 204-0 and 204-1. Any number of cores, caching and home agents, compute dies, and input output (IO) dies can be used.

Devices 206-0 to 206-M can include at least an accelerator, graphics processing unit (GPU), storage device, memory device, network interface device, or other circuitry and software described with respect to FIG. 8.

In some examples, IO dies 204-0 and 204-1 can operate in a manner consistent at least with Infinity Fabric from Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification version 1.0 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

In some examples, for particular addressable memory ranges accessible to multiple processor cores, a home agent (HA) of a CHA can attempt to achieve data consistency among the memory devices and caches of processor cores 202-0 to 202-2. A caching agent (CA) of a CHA can attempt to determine whether another processor core has access to the same cache line and corresponding memory address to determine cache coherency. Where another processor core has access to the same cache line and corresponding memory address, the CA can provide data from its cache slice or obtain a copy of data from another core's cache.

Various examples described herein can allocate a CA or CHA that manages a MMIO address range and memory address range to a core so that the core and CA are physically proximate or at least positioned on a same die. Allocating a CA to memory addresses can occur using a hash algorithm, and can be set by firmware, a core, or circuitry. A processor core can execute a process (e.g., virtual machine, microservice, container, or others) and an address range allocated to the process can include a MMIO address range and memory address range assigned to a CA that is physically proximate to the core. A developer of the process can restrict an accessible MMIO address range and memory address range.

Various examples of allocating MMIO address ranges to CA are described herein. For example, MMIO addresses ranges or regions can be allocated to cores and CA in a same processor subsocket, compute die, or other manners of physical proximity.

A die can include with an integrated circuit, cut from a larger silicon wafer. A die can include one or more of: a processor, memory, interconnect, device interface, and other circuitry. Communications between devices can take place using a network that provides die-to-die communications; chip-to-chip communications; circuit board-to-circuit board communications; and/or package-to-package communications. A die-to-die communications can utilize Embedded Multi-Die Interconnect Bridge (EMIB) or an interposer.

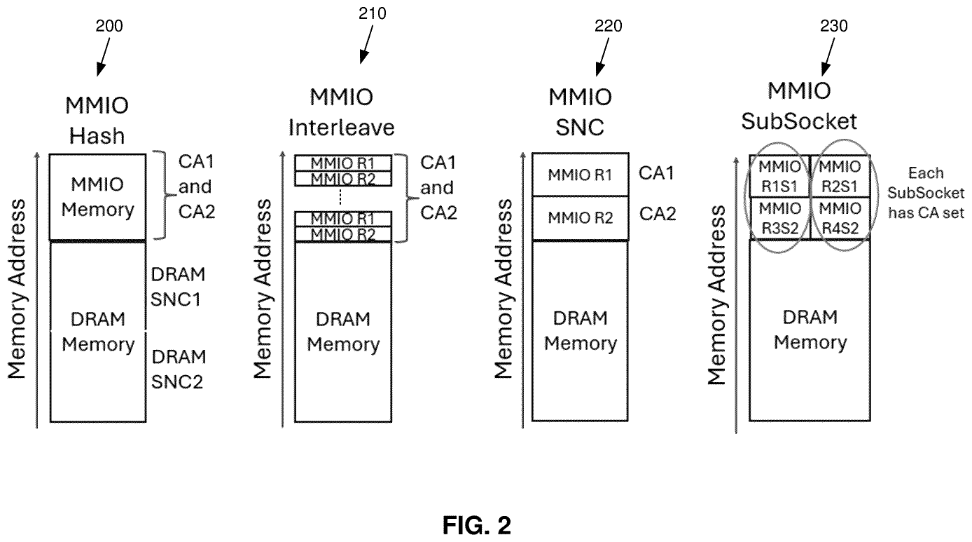

FIG. 2 depicts an example of MMIO and DRAM memory address allocations. A processor core-executed operating system (OS) (not shown) can set up and configure MMIO hardware regions. For example, in configuration 200, a MMIO memory can be allocated to multiple caching agents irrespective of a die on which the caching agent is located, which can lead to a core issuing an MMIO request to a caching agent on a different die. In addition, memory addresses in volatile memory (e.g., dynamic random access memory (DRAM)), can be allocated to different SNCs, SNC1 and SNC2.

For one MMIO region per memory caching domain, the worst-case MMIO latency is where the requesting core is in one SNC domain and the caching agent/controller for the MMIO address is in another SNC region and the physical I/O is on the same side of the die complex (the die complex is the collection of connected dies that make up the socket) as the requesting core. Core in SNC region 1, CA in SNC region 2. IO is up top of SNC region 1 in separate or in region. Arrow length represents latency. Latency increases when switch SNC regions across die.

For example, in configuration 210, MMIO address regions R1 and R2 can be interleaved, but CA1 is allocated to interleaved R1 whereas CA2 is allocated to interleaved R2. Addresses ending in an odd number can be allocated to a first I/O circuitry whereas addresses ending in an odd value can be allocated to a second I/O circuitry. Interleaving even addresses for R1 and odd addresses R2 can allow for selecting a particular I/O circuitry (e.g., first or second I/O circuitry) to access a device. By contrast, reading sequential addresses can utilize all possible connections between the dies, which may increase bandwidth and latency.

For example, in configuration 220, a MMIO memory address region R1 can be allocated to a first caching agent (CA1) and a MMIO memory address region R2 can be allocated to a second caching agent (CA2). A core that utilizes MMIO region R1 can access CA1 and the core and CA1 can be positioned on a same die so that cross die transactions are not performed. A core that utilizes MMIO region R2 can access CA2 and the core and CA2 can be positioned on a same die so that cross die transactions are not performed.

For example, in configuration 230, a first MMIO memory address region R1S1 can be allocated to a first caching agent (CA1) and a first subsocket S1, a second MMIO memory address region R1S2 can be allocated to a second caching agent (CA2) and a first subsocket S2, a third MMIO memory address region R2S1 can be allocated to a first caching agent (CA1) and a first subsocket S2, and a fourth MMIO memory address region R2S2 can be allocated to a second caching agent (CA2) and a second subsocket S2.

A socket can include a ball grid array (BGA), Pin Grid Array (PGA), Land Grid Array (LGA), or other interface that can couple a processor to a circuit board (e.g., printed circuit board (PCB)), without soldering the processor to the circuit board. Platforms can scale up or down a number of sockets in a partition and boot either as multi-socket platform or as multi-node systems. This scalability allows a two-socket (2S) platform to boot either as one platform with two sockets (1×2S) or as two platforms with one socket each (2×1S) or a four-socket (4S) platform to boot as two platforms with two sockets each (2×2S).

Socket level partitioning allows a platform with multiple processor sockets to boot in a single system that executes a single operating system (OS) or multiple independent single socket systems that execute multiple operating systems. For example, in a non-partitioned mode, a 2S platform can operate as a single node, and resources connected to the two processor sockets are part of the single node. Processors in the non-partitioned mode, including software (e.g., OS or processes) can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a 2S platform can operate as two separate sockets and can operate in independent power states (e.g., S0, S5, and so on), perform separate error handling, and not share one or more of: connected memory, cores in different sockets, cache, isolated input/output (I/O) communication interfaces, or device interface-connected devices. Moreover, in partitioned mode, different sockets can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more root of trust devices that authenticate or validate different boot firmware, or others. Multiple processors can execute separate boot firmware code and handoff platform control to operating systems (OSs) executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states.

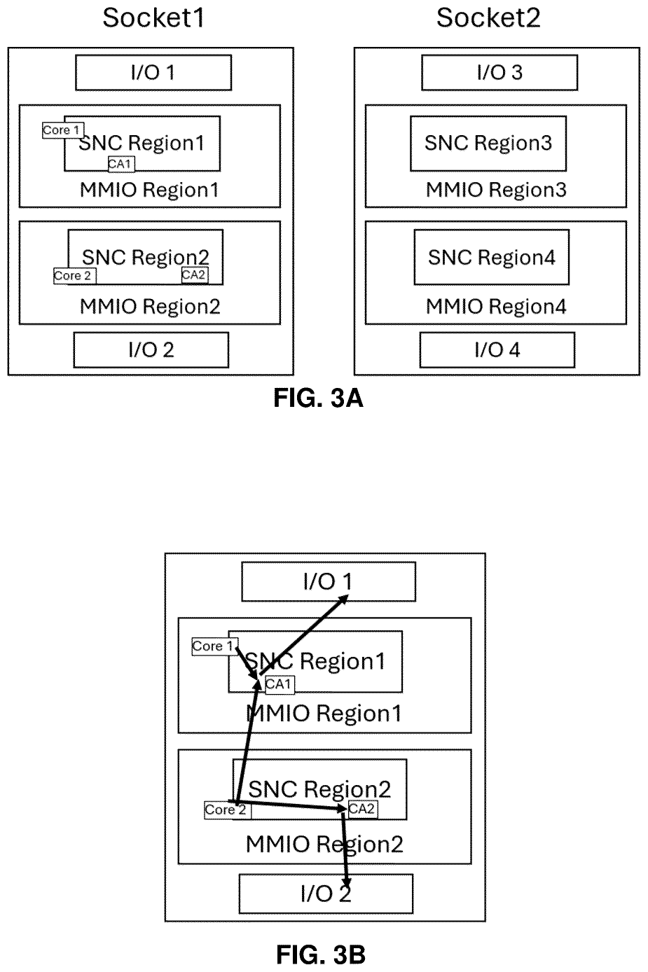

FIG. 3A depicts an example of allocations of multiple MMIO regions in a processor socket. An SNC can include cores that are physically proximate to CA and are allocated memory addresses and MMIO addresses. Instead of multiple SNC being allocated to a single MMIO region, an MMIO region can be allocated to an SNC that reduce the MMIO latency because an access from a core 1 to CA1 can be physically short distance. In addition, the CA1 can issue a request with an address to an I/O1 that does not cross another SNC region to send to the request to a PCIe network interface device, accelerator, or others. Similarly, an access from a core 2 to CA2 and CA1 can issue a request with an address to an I/O2 that does not cross another SNC region to send to the request to a PCIe network interface device, accelerator, or others.

By splitting the MMIO region among multiple SNCs, a core can be allocated to a CA that is closer to the core that uses the CA and an I/O utilized by the CA to access a device is proximate to the CA. Allocating the CA to memory addresses occurs using hash algorithm, set by firmware, core, circuitry, or set hash algorithm for MMIO and SNC.

FIG. 3B depicts an allocation of a MMIO region to an SNC that reduces the MMIO latency. For example, MMIO region 1 can be allocated to SNC 1, which include a group of cores and CA that are physically proximate to one another on a die or board. For example, MMIO region 2 can be allocated to SNC 2, which can include a group of cores and CA that are physically proximate to one another on a die or board. Moreover, cores and CA in SNC 1 utilize I/O 1 for accessing devices. By contrast, a core1 in SNC 1 utilizing I/O 2 can increase latency of accesses to a device as accessing I/O 2 can be a longer distance than accessing I/O 1.

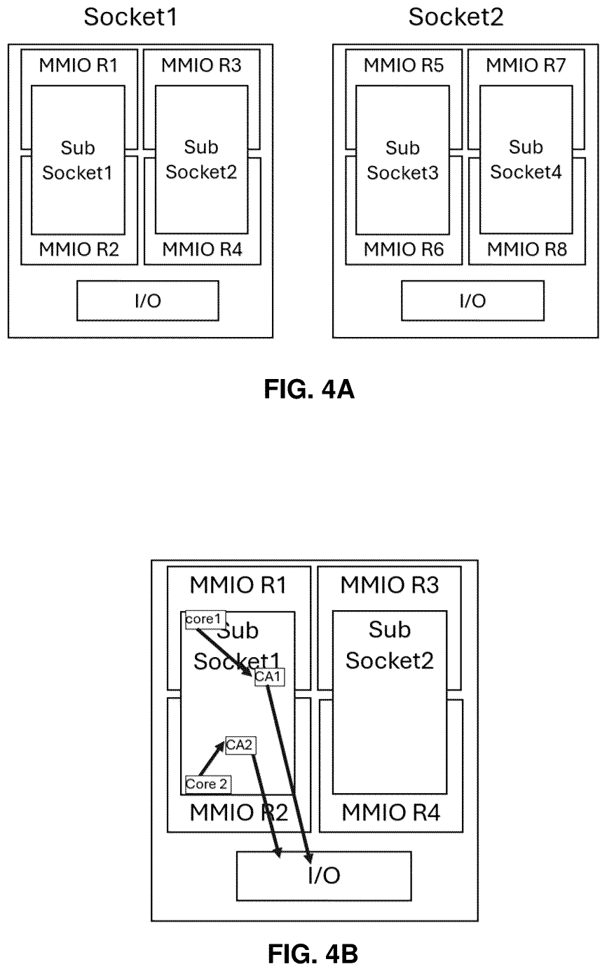

Cores and CA within a sub-socket can be disbursed within a sub-socket. FIG. 4A depicts allocation of multiple MMIO regions to a sub-socket memory caching domain so that cores and CA allocated to an MMIO region can be physically proximate to one another. A span of the MMIO region being less than an entirety of the sub-socket memory caching domain can reduce a distance between a core and CA and a shortest path to from the CA to an I/O when servicing an MMIO request and issuing a memory access request to a device connected to an I/O.

Cores can have access to full MMIO region and can access any I/O but limit caching agents accessible to a core can control latency of MMIO accesses. For example, in FIG. 4A, a same MMIO address can be mapped to both MMIO regions R1 and R2 whereas a same MMIO address can be mapped to both MMIO regions R3 and R4. A caching agent can be allocated to a core that has a corresponding shortest signal path to the core.

FIG. 4B shows an example of allocations of MMIO regions to cores. For example, MMIO R1 can be allocated to a core C1 and CA1 because the core C1 and CA1 are physically proximate. For example, MMIO R2 can be allocated to a core C2 and CA2 because the core C2 and CA2 are physically proximate. For an MMIO address mapped to both MMIO R1 and R2, to access such address, a core C1 can utilize CA1 whereas a core C2 can utilize CA2. As a single I/O is used, the CA allocated to a core can be irrespective of distance from CA to IO.

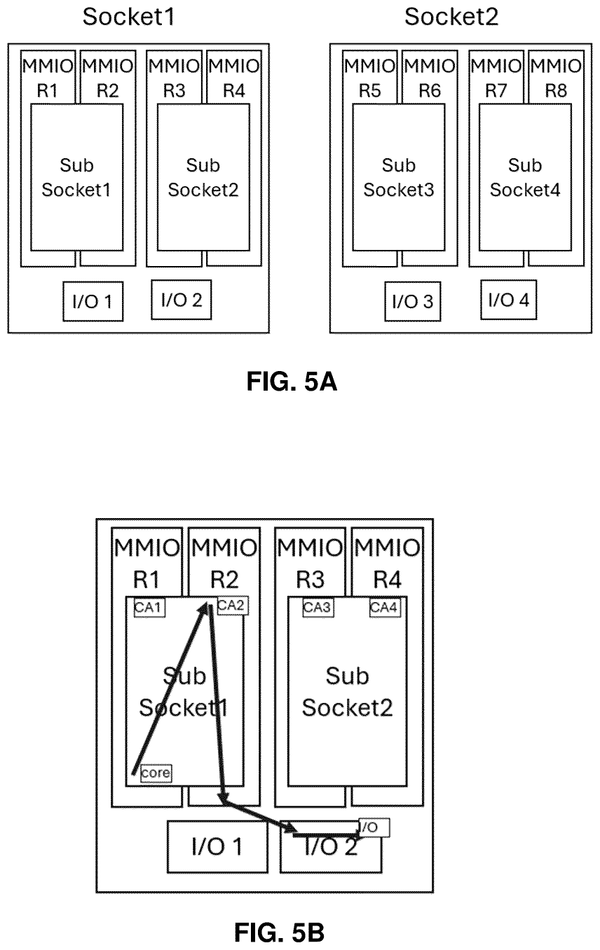

FIG. 5A shows an example of allocations of MMIO regions to cores of sub sockets. For example, MMIO regions R1 and R2 can be allocated to subsocket 1, MMIO regions R3 and R4 can be allocated to subsocket 2, MMIO regions R5 and R6 can be allocated to subsocket 3, and MMIO regions R7 and R8 can be allocated to subsocket 4. An MMIO address may or may not be mapped to multiple MMIO regions. A sub socket can include cores and caching agents and a caching agent can be allocated to an MMIO region to provide direct access to an I/O to a device instead of traversing multiple I/Os to send a request to PCIe device.

FIG. 5B shows an example allocation of caching agent to core. Subsocket 1 can include core and CA1 and CA2. In this example, CA1 is allocated to utilize I/O 1 whereas CA2 is allocated to utilize I/O 2. For the core to access a device that is accessible through I/O 1, the core is allocated to CA2 and MMIO R2 is allocated to CA2. Were CA1 allocated to the core and MMIO R1 was allocated to CA1, then the core would access a device connected to I/O 2 through I/O 1 and then I/O 2.

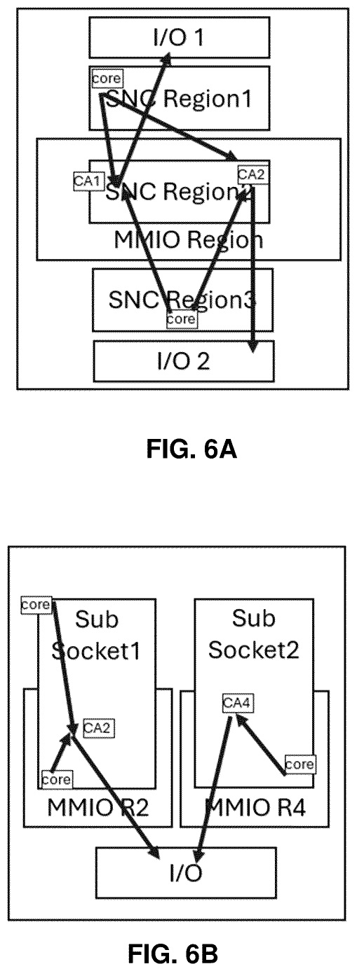

FIG. 6A depicts an example of allocation of an MMIO region to an SNC. In this example, I/O 1 and 2 are positioned at opposite ends of a die and caching agents CA1 and CA2 are positioned approximately midway between I/O 1 and I/O 2. A number of caching agents that handle the MMIO requests can occur by positioning the caching agents physically midway between multiple I/Os. However, reducing the number of caching agents per MMIO domain can involve more processor and memory resources per caching agent because the caching agent supports a greater fraction of the peak MMIO bandwidth. CA1 and CA2 can be assigned to a same MMIO region. In this example, a core in an SNC domain can be assigned to either CA1 or CA2. Latency for completion of an MMIO from selection of CA1 or CA2 may be approximately the same.

FIG. 6B depicts an allocation of an MMIO region to a subsocket. In this example, subsockets 1 and 2 can access a same I/O to access a device. A first MMIO region (MMIO R2) can be allocated to CA2 of a subsocket 1 and cores of subsocket 1 can be allocated to the CA2. A second MMIO region (MMIO R4) can be allocated to CA4 of a subsocket 2 and cores of subsocket 2 can be allocated to the CA4. CA2 and CA4 can be physically positioned in a die to be relatively equidistant from the cores. An MMIO region need not utilize all CAs in a subsocket.

Other potential configurations are possible as well. In general, the number of MMIO regions per caching domain can be increased to where there are as many MMIO regions as there are cache agents/controller per caching domain. In addition, multiple MMIO regions can be created within a caching domain and not all the caching agents/controllers within each of these regions need to participate in the MMIO processing.

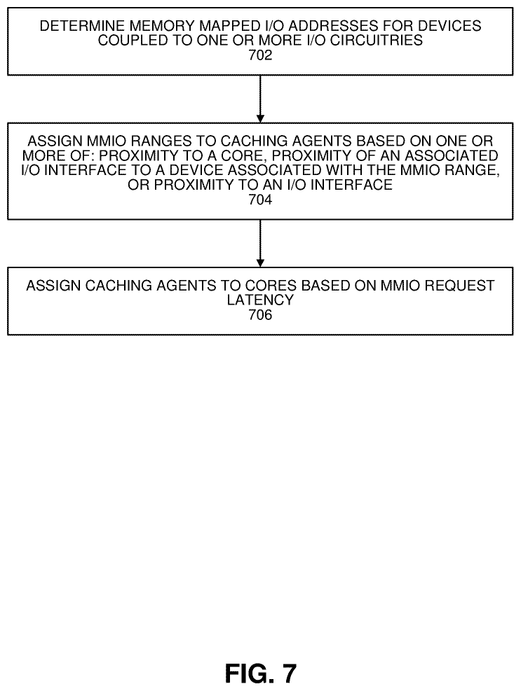

FIG. 7 depicts an example process. The process can be performed by a firmware or operating system, in some examples. At 702, an MMIO address range can be determined for associated devices. For example, devices can be accessible through an I/O interface via caching agents or via multiple hops through I/O interfaces.

At 704, multiple MMIO address ranges can be assigned to caching agents based on latency of communication with the associated devices. The latency of communication can be based on physical proximity of caching agents to the I/O interfaces and I/O interfaces to the associated devices or signal path distance from a caching agent to an I/O interface. For example, a first of the MMIO address ranges can be assigned to a first caching agent that accesses devices coupled to an I/O that is physically closer to the first caching agent than a second caching agent. For example, a second of the MMIO address ranges can be assigned to the second caching agent that accesses devices coupled to an I/O that is physically closer to the second caching agent than the first caching agent.

For example, for a subsocket, a first of the MMIO address ranges can be assigned to a first caching agent and a second of the MMIO address ranges can be assigned to a second caching agent. In the subsocket, the first caching agent can be assigned to a first core based on physical proximity between the first caching agent and the first core. In the subsocket, the second caching agent can be assigned to a second core based on physical proximity between the second caching agent and the second core.

For example, for multiple subsockets and multiple I/Os, a first of the MMIO address ranges can be assigned to a first caching agent that utilizes a first I/O that is directly connected to devices associated with the first of the MMIO address ranges. In addition, a second of the MMIO address ranges can be assigned to a second caching agent that utilizes a second I/O that is directly connected to devices associated with the second of the MMIO address ranges.

At 706, multiple MMIO address ranges can be allocated to cores so that the cores use particular caching agents to handle MMIO access requests.

FIG. 8 depicts a system. In some examples, cores can be associated with caching agents and MMIO address ranges to reduce MMIO request latency, as described herein. System 800 includes processor 810, which provides processing, operation management, and execution of instructions for system 800. Processor 810 can include any type of microprocessor, core, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Graphics interface 840 can provide an interface to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples, and includes at least one non-transitory computer-readable medium, comprising instructions stored thereon, that if executed by one or more processors, cause the one or more processors to: allocate a first of multiple memory-mapped input/output regions to a first sub-non-uniform memory access cluster and allocate a second of the memory-mapped input/output regions to a second sub-non-uniform memory access cluster.

Example 2 includes one or more earlier or later examples, and includes instructions stored thereon, that if executed by one or more processors, cause the one or more processors to: allocate the second of the memory-mapped input/output regions to a third sub-non-uniform memory access cluster.

Example 3 includes one or more earlier or later examples, wherein the first sub-non-uniform memory access cluster comprises a core and a caching agent.

Example 4 includes one or more earlier or later examples, wherein addresses of the first of multiple memory-mapped input/output regions is interleaved among addresses of the second of multiple memory-mapped input/output regions.

Example 5 includes one or more earlier or later examples, wherein the allocate the first of multiple memory-mapped input/output regions to a first sub-non-uniform memory access cluster comprises: assigning the first memory-mapped input/output region to a caching agent of the first sub-non-uniform memory access cluster that processes accesses to the first memory-mapped input/output region.

Example 6 includes one or more earlier or later examples, and includes instructions stored thereon, that if executed by one or more processors, cause the one or more processors to: allocating multiple memory-mapped input/output regions to a sub-socket; allocating a first strict subset of the multiple memory-mapped input/output regions to a first core and first caching agent; and allocating a second strict subset of the multiple memory-mapped input/output regions to a second core and second caching agent.

Example 7 includes one or more earlier or later examples, wherein a number of memory-mapped input/output regions corresponds to a number of cache agents per caching domain.

Example 8 includes one or more earlier or later examples, wherein the allocate the first of multiple memory-mapped input/output regions to the first sub-non-uniform memory access cluster is based on one or more of: proximity of a caching agent in the first sub-non-uniform memory access cluster to a core, proximity of an associated input/output (I/O) interface circuitry to a device associated with the first memory-mapped input/output region, or proximity of a caching agent in the first sub-non-uniform memory access cluster to the I/O interface.

Example 9 includes one or more earlier or later examples, wherein a firmware is to allocate the first memory-mapped input/output region to the first sub-non-uniform memory access cluster and allocate the second memory-mapped input/output regions to the second sub-non-uniform memory access cluster.

Example 10 includes one or more earlier or later examples, and includes a method that includes: assigning multiple memory-mapped input/output ranges to caching agents based on one or more of: proximity of a caching agent to a core, proximity of an associated input/output (I/O) interface to a device associated with an memory-mapped input/output range, or proximity to an I/O interface.

Example 11 includes one or more earlier or later examples, wherein the assigning multiple memory-mapped input/output ranges to caching agents comprises: allocating a first memory-mapped input/output region to a first sub-non-uniform memory access cluster and allocating a second memory-mapped input/output region to a second sub-non-uniform memory access cluster.

Example 12 includes one or more earlier or later examples, wherein: the first sub-non-uniform memory access cluster comprises a first core and a first caching agent and the second sub-non-uniform memory access cluster comprises a second core and a second caching agent.

Example 13 includes one or more earlier or later examples, and includes allocating multiple memory-mapped input/output regions to a sub-socket; allocating a first strict subset of the multiple memory-mapped input/output regions to a first core and first caching agent; and allocating a second strict subset of the multiple memory-mapped input/output regions to a second core and second caching agent.

Example 14 includes one or more earlier or later examples, wherein a number of memory-mapped input/output regions corresponds to a number of cache agents per caching domain.

Example 15 includes one or more earlier or later examples, and includes an apparatus that includes: multiple processors; multiple caching agents; and an interface to a device, wherein: a first memory-mapped input/output range is assigned to a first caching agent of the multiple caching agents and a second memory-mapped input/output range is assigned to a second caching agent of the multiple caching agents.

Example 16 includes one or more earlier or later examples, wherein the first and second memory-mapped input/output ranges are assigned based on one or more of: proximity of a caching agent to a core, proximity of an associated input/output (I/O) interface to a device associated with an memory-mapped input/output range, or proximity to an I/O interface.

Example 17 includes one or more earlier or later examples, wherein: a first processor of the processors is associated with the first caching agent and a second processor of the processors is associated with the second caching agent.

Example 18 includes one or more earlier or later examples, wherein: multiple memory-mapped input/output regions are allocated to a sub-socket; a first strict subset of the multiple memory-mapped input/output regions is allocated to a first core and the first caching agent; and allocating a second strict subset of the multiple memory-mapped input/output regions to a second core and the second caching agent.

Example 19 includes one or more earlier or later examples, wherein a number of memory-mapped input/output regions corresponds to a number of cache agents per caching domain.

Example 20 includes one or more earlier examples, wherein addresses of the first memory-mapped input/output range is interleaved among addresses of the second memory-mapped input/output range.

1. At least one non-transitory computer-readable medium, comprising instructions stored thereon, that if executed by one or more processors, cause the one or more processors to:
allocate a first of multiple memory-mapped input/output regions to a first sub-non-uniform memory access cluster and
allocate a second of the memory-mapped input/output regions to a second sub-non-uniform memory access cluster.

2. The non-transitory computer-readable medium of claim 1, comprising instructions stored thereon, that if executed by one or more processors, cause the one or more processors to:
allocate the second of the memory-mapped input/output regions to a third sub-non-uniform memory access cluster.

3. The non-transitory computer-readable medium of claim 1, wherein the first sub-non-uniform memory access cluster comprises a core and a caching agent.

4. The non-transitory computer-readable medium of claim 1, wherein addresses of the first of multiple memory-mapped input/output regions is interleaved among addresses of the second of multiple memory-mapped input/output regions.

5. The non-transitory computer-readable medium of claim 1, wherein the allocate the first of multiple memory-mapped input/output regions to a first sub-non-uniform memory access cluster comprises:
assigning the first memory-mapped input/output region to a caching agent of the first sub-non-uniform memory access cluster that processes accesses to the first memory-mapped input/output region.

6. The non-transitory computer-readable medium of claim 1, comprising instructions stored thereon, that if executed by one or more processors, cause the one or more processors to:
allocating multiple memory-mapped input/output regions to a sub-socket;
allocating a first strict subset of the multiple memory-mapped input/output regions to a first core and first caching agent; and
allocating a second strict subset of the multiple memory-mapped input/output regions to a second core and second caching agent.

7. The non-transitory computer-readable medium of claim 1, wherein a number of memory-mapped input/output regions corresponds to a number of cache agents per caching domain.

8. The non-transitory computer-readable medium of claim 1, wherein the allocate the first of multiple memory-mapped input/output regions to the first sub-non-uniform memory access cluster is based on one or more of: proximity of a caching agent in the first sub-non-uniform memory access cluster to a core, proximity of an associated input/output (I/O) interface circuitry to a device associated with the first memory-mapped input/output region, or proximity of a caching agent in the first sub-non-uniform memory access cluster to the I/O interface.

9. The non-transitory computer-readable medium of claim 1, wherein a firmware is to allocate the first memory-mapped input/output region to the first sub-non-uniform memory access cluster and allocate the second memory-mapped input/output regions to the second sub-non-uniform memory access cluster.

10. A method comprising:
assigning multiple memory-mapped input/output ranges to caching agents based on one or more of: proximity of a caching agent to a core, proximity of an associated input/output (I/O) interface to a device associated with an memory-mapped input/output range, or proximity to an I/O interface.

11. The method of claim 10, wherein the assigning multiple memory-mapped input/output ranges to caching agents comprises:
allocating a first memory-mapped input/output region to a first sub-non-uniform memory access cluster and
allocating a second memory-mapped input/output region to a second sub-non-uniform memory access cluster.

12. The method of claim 11, wherein:
the first sub-non-uniform memory access cluster comprises a first core and a first caching agent and
the second sub-non-uniform memory access cluster comprises a second core and a second caching agent.

13. The method of claim 10, comprising:
allocating multiple memory-mapped input/output regions to a sub-socket;
allocating a first strict subset of the multiple memory-mapped input/output regions to a first core and first caching agent; and
allocating a second strict subset of the multiple memory-mapped input/output regions to a second core and second caching agent.

14. The method of claim 10, wherein a number of memory-mapped input/output regions corresponds to a number of cache agents per caching domain.

15. An apparatus comprising:
multiple processors;
multiple caching agents; and
an interface to a device, wherein:
a first memory-mapped input/output range is assigned to a first caching agent of the multiple caching agents and
a second memory-mapped input/output range is assigned to a second caching agent of the multiple caching agents.

16. The apparatus of claim 15, wherein the first and second memory-mapped input/output ranges are assigned based on one or more of: proximity of a caching agent to a core, proximity of an associated input/output (I/O) interface to a device associated with an memory-mapped input/output range, or proximity to an I/O interface.

17. The apparatus of claim 15, wherein:
a first processor of the processors is associated with the first caching agent and
a second processor of the processors is associated with the second caching agent.

18. The apparatus of claim 15, wherein:
multiple memory-mapped input/output regions are allocated to a sub-socket;
a first strict subset of the multiple memory-mapped input/output regions is allocated to a first core and the first caching agent; and
allocating a second strict subset of the multiple memory-mapped input/output regions to a second core and the second caching agent.

19. The apparatus of claim 15, wherein a number of memory-mapped input/output regions corresponds to a number of cache agents per caching domain.

20. The apparatus of claim 15, wherein addresses of the first memory-mapped input/output range is interleaved among addresses of the second memory-mapped input/output range.
